(19) United States
(12) Patent Application Publication
(10) Pub. No.: US 2008/0216863 A1
(43) Pub. Date: Sep. 11, 2008

(54) METHODS AND APPARATUS FOR MONITORING THE ROTATION OF A SUBSTRATE DURING CLEANING

(75) Inventors: Gary C. Ettinger, Cupertino, CA (US); Joseph Yudovsky, Campbell, CA (US)

Correspondence Address: DUGAN & DUGAN, PC, 245 Saw Mill River Road, Suite 309, Hawthorne, NY, 10532, US

(73) Assignee: APPLIED MATERIALS, INC.

(21) Appl. No.: 12/044,728

(22) Filed: Mar. 7, 2008

Related U.S. Application Data
(60) Provisional application No. 60/894,102, filed on Mar. 9, 2007.

(51) Int. Cl. B08B 3/00; G01P 3/36

(52) U.S. Cl. 134/1; 134/113; 356/28

(57) ABSTRACT

Systems, methods, and apparatus for monitoring rotation of a substrate during cleaning are disclosed. The invention may include a substrate cleaner adapted to support and clean a substrate; an optical source adapted to provide a light beam having a path within the substrate cleaner; and an optical sensor positioned along the path so as to receive the light beam from the optical source and adapted to detect an orientation feature on the substrate when the orientation feature traverses the path. The optical sensor includes an array of light detectors. Numerous additional aspects are disclosed.

The present application claims priority to U.S. Provisional Application No. 60/894,102, filed Mar. 9, 2007 and entitled “METHODS AND APPARATUS FOR MONITORING THE ROTATION OF A SUBSTRATE DURING CLEANING,” the content of which is hereby incorporated by reference herein in its entirety for all purposes.

### FIELD OF THE INVENTION

The present invention relates generally to electronic device manufacturing and more particularly to methods and apparatus for monitoring the rotation of a substrate during cleaning.

### BACKGROUND OF THE INVENTION

Electronic device manufacturing processes performed on a substrate may include a step of substrate cleaning. In many conventional processes, a substrate is rotated during cleaning, and substrate rotation is monitored to ensure a desired cleaning process occurs.

Conventional apparatus employed to monitor substrate rotation may contact a substrate during cleaning. For example, substrate rotation may be monitored by an idler. A conventional idler is a disk or roller that contacts a substrate and rotates passively therewith so as to match the rotation of the substrate. Unfortunately, an apparatus that contacts a substrate may generate particles that may contaminate and/or damage devices formed on the substrate. In addition to wear and particle generation, such a contacting apparatus may be susceptible to slipping due to fluids used during cleaning.

Optical methods also may be used to monitor rotation of a substrate. Conventional optical methods, for example, may employ a through beam optical source and optical sensor combination. The optical source and sensor combination may be employed to monitor the rotation of a substrate by detecting an orientation feature of the substrate (e.g., a notch, a flat, and/or the like) as the substrate rotates. However, such conventional optical methods may be error prone due to variation in the location of the substrate's orientation feature relative to the sensor, (e.g., due to manufacturing variations) in addition to deflection of the light beam due to the wet environment in which the substrate is cleaned.

Accordingly, improved methods and apparatus for monitoring the rotation of a substrate during cleaning are desired.

### SUMMARY OF THE INVENTION

In some embodiments, the present invention provides a system for monitoring rotation of a substrate during cleaning. The invention includes a substrate cleaner adapted to support and clean a substrate; an optical source adapted to provide a light beam having a path within the substrate cleaner; and an optical sensor positioned along the path so as to receive the light beam from the optical source and adapted to detect an orientation feature on the substrate when the orientation feature traverses the path. The optical sensor includes an array of light detectors.

In some other embodiments, the present invention provides an apparatus for monitoring rotation of a substrate. The invention includes an optical source adapted to provide a light beam having a path partially incident on a substrate; and an optical sensor positioned along the path so as to receive the light beam from the optical source and adapted to detect an orientation feature on the substrate when the orientation feature traverses the path. The optical sensor includes an array of light detectors.

In yet other embodiments, the present invention provides a method for monitoring rotation of a substrate. The invention includes projecting a light beam, having a path, within a substrate cleaner; traversing the path with an orientation feature of a substrate; and changing a state of at least one light detector of an optical sensor that includes an array of light detectors, when the orientation feature traverses the path.

Other features and aspects of the present invention will become more fully apparent from the following detailed description of the preferred embodiments, the appended claims and the accompanying drawings.

### BRIEF DESCRIPTION OF THE DRAWINGS

FIGS. 1A and 1B illustrate front perspective views of an orientation feature of a substrate being detected by an optical sensor in accordance with some embodiments of the present invention.

FIG. 2 illustrates an enlarged perspective view of the optical sensor and optical source of FIGS. 1A and 1B with a light beam illuminating one or more light detectors of an array of light detectors in accordance with an embodiment of the present invention.

FIG. 3 illustrates an enlarged perspective view of the optical sensor and optical source of FIGS. 1A and 1B with a light beam illuminating a plurality of light detectors of an array of light detectors when an orientation feature of a substrate is displaced in accordance with an embodiment of the present invention.

FIG. 4 illustrates an enlarged perspective view of the optical sensor and optical source of FIGS. 1A and 1B with a light beam overlapping an array of light detectors when a droplet is on an orientation feature of a substrate, in accordance with an embodiment of the present invention.

FIGS. 5A and 5B illustrate front perspective views of an orientation feature on a substrate being detected by an optical sensor as a substrate is rotated in accordance with an additional embodiment of the present invention.

FIG. 6 is a flowchart depicting an example method in accordance with some embodiments of the present invention.

### DETAILED DESCRIPTION

The present invention provides improved methods and apparatus for monitoring the rotation of a substrate during cleaning. More specifically, the present invention provides optical methods and apparatus for monitoring the rotation of a substrate during cleaning. In one embodiment, the optical methods and apparatus may include an optical source and an optical sensor having an array of light detectors. By employing an array of light detectors, the optical sensor may be used in a wet environment and may enable cleaning equipment to be manufactured with larger tolerances (as described further below).

The various parts of a cleaning apparatus have mechanical tolerances. The aggregate sum of the mechanical tolerances of these parts may cause equipment to equipment variations in the position of components within the cleaning apparatus. For example, mounts for optical sources and optical sensors and rollers that support and rotate a substrate during cleaning may be in slightly different relative positions in different but otherwise identical machines. In a conventional cleaning apparatus that uses an optical source and optical sensor to monitor substrate rotation, such positional variations may displace the optical source and/or sensor relative to an orientation feature of a substrate being cleaned within the apparatus. In one or more embodiments of the present invention, an inventive light detector array is employed as the optical sensor, and may be dimensioned so as to accurately and reliably detect an orientation feature of a substrate despite such displacement. Thus, a light detector array may be employed without requiring a user to make manual positioning adjustments of the optical source, optical sensor, rollers and/or the like of the cleaning apparatus to compensate for equipment to equipment variations.

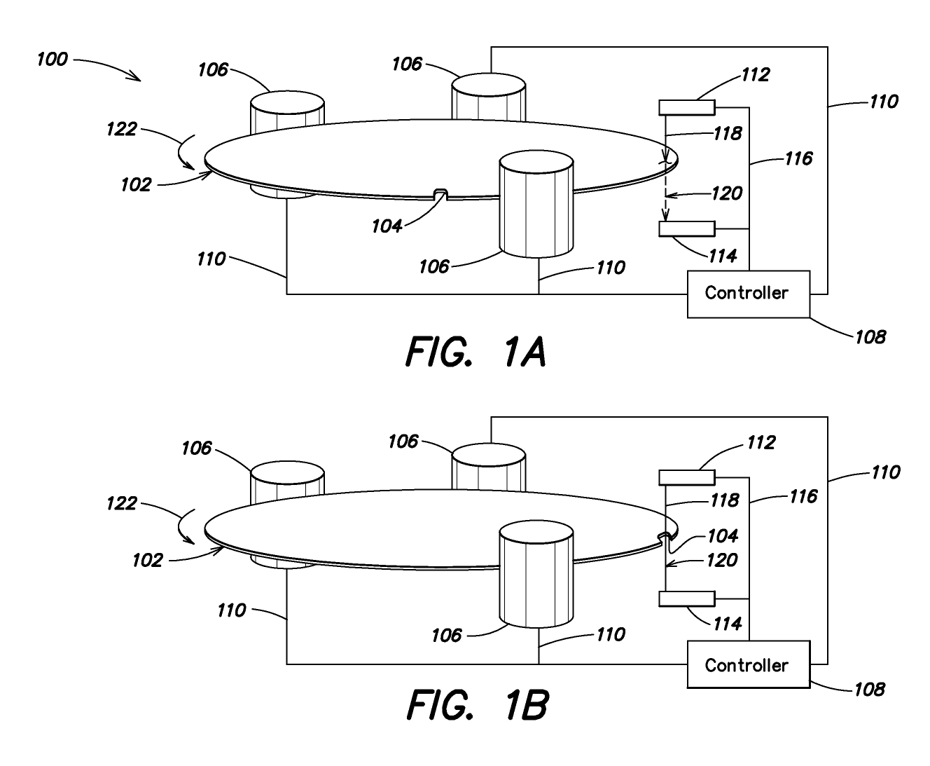

With reference to FIGS. 1A and 1B, a first exemplary cleaning apparatus 100 is provided that may hold, rotate and clean a substrate 102 having an orientation feature 104. The apparatus 100 may include rollers 106 disposed such that the sides of the rollers 106 contact an edge of the substrate 102. One or more of the rollers 106 may be coupled to a controller 108 via first signal lines 110. The cleaning apparatus 100 also includes an optical source 112 and an optical sensor 114 coupled to the controller 108 via second signal lines 116. The optical source 112 may emit light so as to form a light beam 118 having a path 120 that extends between the optical source 112 and the optical sensor 114 when the orientation feature 104 traverses the path 120. Otherwise the light beam 118 extends from the optical source 112 to a major surface of the substrate 102 and is blocked by the substrate 102 (e.g., absorbed, deflected and/or reflected).

The rollers 106 may be employed to rotate the substrate 102. The substrate 102 may rotate in a direction depicted by arrow 122 about an axis perpendicular to the major surface of the substrate 102. In the same or alternative embodiments, the substrate 102 may be rotated in a direction opposite to that of arrow 122. The rollers 106 may rotate the substrate 102 at a specified rotation frequency. For example, the specified rotation frequency may be communicated from the controller 108 to the rollers 106 via the first signal lines 110. Any suitable number of rollers may be used. In some embodiments, a substrate support or pedestal (not shown) may be used to rotate the substrate 102. Such a support may include a chuck (e.g., vacuum chuck, electrostatic chuck, etc.) for securely holding the substrate.

As depicted in FIG. 1A, the cleaning apparatus 100 may rotate the substrate 102 such that the orientation feature 104 rotates about an axis substantially perpendicular to the major surface of the substrate 102. When the feature 104 is rotated away from the path 120, the light beam 118 is reflected, deflected and/or absorbed by the substrate 102 so as to not illuminate the optical sensor 114.

With reference to FIG. 1B, when the orientation feature 104 is rotated so as to traverse the path 120, the light beam 118 illuminates the optical sensor 114. In this manner, the orientation feature 104 may be detected. The optical sensor 114 may provide an electrical signal (e.g., voltage, current, and/or the like) to the controller 108 indicative of the orientation feature 104 traversing the path 120. In some embodiments, the optical source 112, optical sensor 114 and/or controller 108 may communicate wirelessly.

The controller 108 may analyze any signal provided by the optical sensor 114 to determine the rotation frequency of the substrate 102. In some embodiments, the rotation frequency of the substrate 102 may be compared with a specified rotation frequency provided to the controller 108 by a user of the system 100 (e.g., to allow feedback control of the substrate rotation rate).

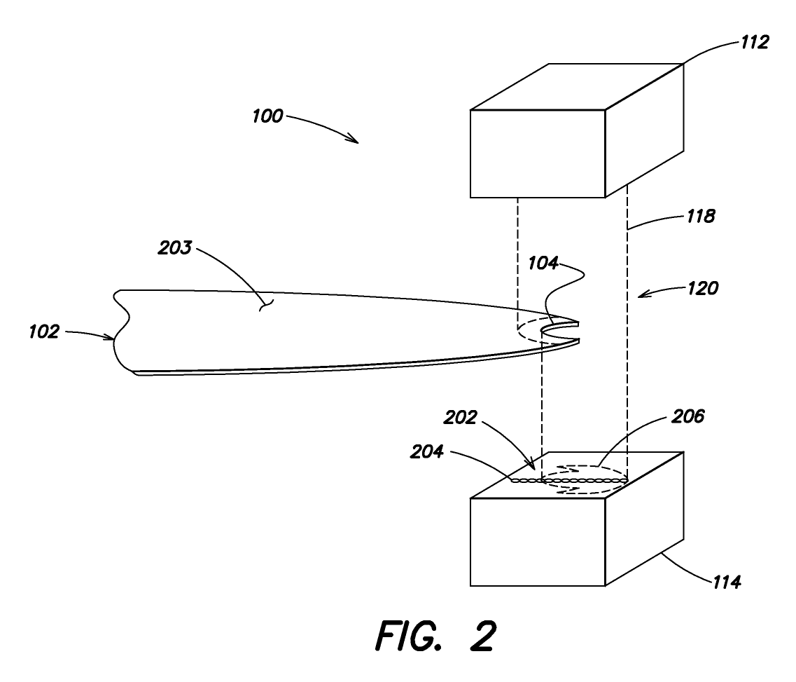

FIG. 2 illustrates an enlarged perspective view of the optical sensor 114 and the optical source 112 of FIGS. 1A and 1B. With reference to FIG. 2, the optical sensor 114 may include an array 202 of light detectors 204 (e.g., 2, 3, 4, 5, 6 or more light detectors linearly or otherwise arranged (for example, in a rectangular shape, an “X-shaped” pattern, a two dimensional array, a circular arrangement, a curved line arrangement, etc.)). In at least one embodiment of the invention, the light detectors 204 may have small detection areas (relative to the width of the light beam 118), directional sensitivity, and/or the like. Any suitable light detectors may be used.

As discussed above in reference to FIG. 1B, the optical source 112 may produce a light beam 118. In at least one embodiment of the invention and as shown in FIG. 2, the light beam 118 output by the optical source 112 may have a width greater than the orientation feature 104 of the substrate 102 (e.g., the optical source 112 may include one or more light sources). Accordingly, the major surface 203 of the substrate 102 may obstruct a portion of the light beam 118. The portion of the light beam 118 that passes by and is not obstructed by the major surface 203 of the substrate 102 has a profile that is determined, at least in part, by the edge of the substrate 102 as shown by illumination profile 206.

The illumination profile 206 may illuminate only a portion of the optical sensor 114. However, when the orientation feature 104 is not traversing the path 120, a greater portion of the light beam 118 is obstructed by the substrate 102 and the illumination profile 206 is smaller. Thus, some of the light detectors 204 that are illuminated when the orientation feature 104 traverses the path 120 are not illuminated when the orientation feature 104 is not traversing the path 120. As a result, as the substrate 102 rotates, the optical sensor 114 may provide one or more signals to the controller 108 that indicate some light detectors 204 of the array 202 only intermittently receive a portion of the light beam 118.

The controller 108 may use the one or more signals from the array 202 to determine the rotation frequency of the substrate 102. As discussed above, the rotation frequency of the substrate 102 may be compared with a user specified rotation frequency provided by the controller 108 to the rollers 106. If desired, the controller 108 may adjust substrate rotation speed to compensate for any differences between the measured substrate rotation frequency and the specified rotation frequency. In this manner, real-time, on-the-fly substrate rotation rate control may be provided.

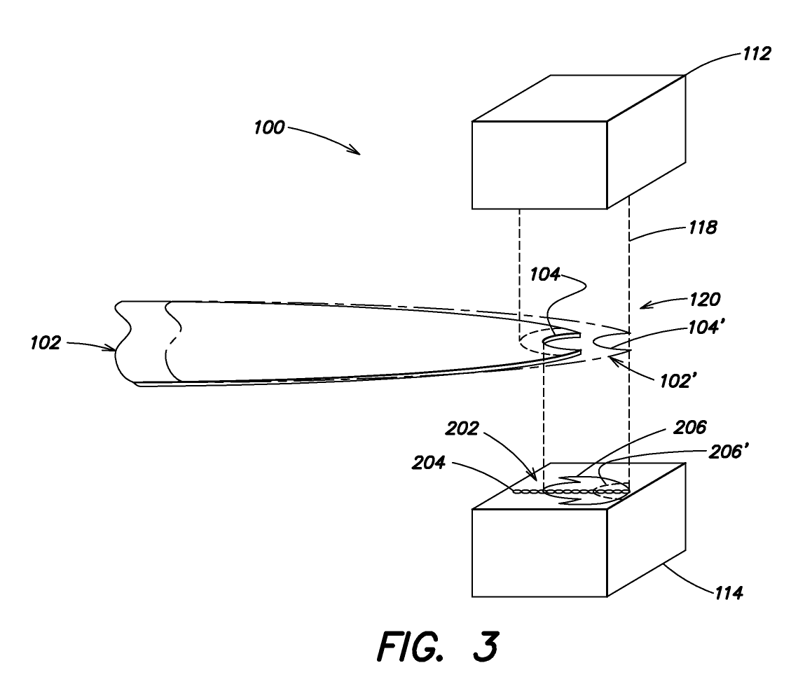

FIG. 3 illustrates an enlarged perspective view of the optical sensor 114 and source 112 with the light beam 118 illuminating a plurality of the light detectors 204 of the array 202 when the orientation feature 104 is displaced. For example, due to equipment to equipment variations, a first apparatus 100 may not hold a substrate at the same position as a second apparatus 100 relative to the optical sensor 114. Thus, a substrate may be displaced within any given apparatus 100 as shown by substrate 102′ in FIG. 3. Compared with the nominal substrate location depicted by the substrate 102, the displaced position of substrate 102′ causes the obstruction of a greater portion of the light beam 118. As a result, a reduced illumination profile 206′ may be formed for the substrate 102′. As can be observed from FIG. 3, in spite of the displaced position of substrate 102′, the illumination profile 206′ nonetheless illuminates a portion of the array 202. Thus, as the substrate 102′ rotates, the orientation feature 104 may be detected via the intermittent illumination of the light detectors 204 via the illumination profile 206′, and the controller 108 may determine substrate rotation frequency despite the substrate's displacement from the nominal position.

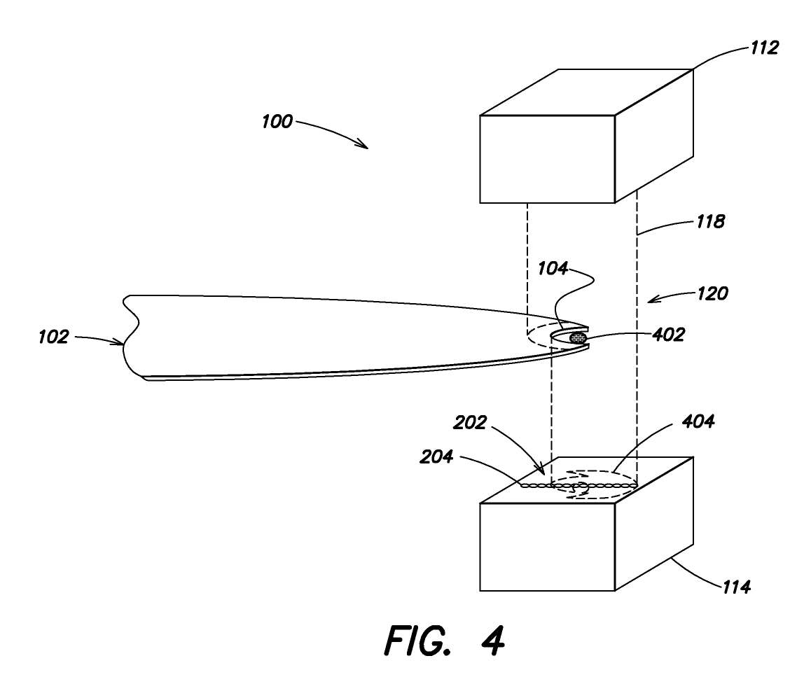

FIG. 4 illustrates a detailed view showing the optical sensor 114 and optical source 112 with the light beam 118 overlapping the array 202 of detectors 204 when a fluid droplet 402 is on the orientation feature 104. As stated, the substrate 102 and/or optical sensor 114 may be in a wet environment during substrate cleaning. As a result, droplet 402 may form on the substrate 102 as illustrated in FIG. 4. Note that the droplet 402 is merely illustrative and other droplet sizes and/or shapes may be present.

When the orientation feature 104 is in the path 120 traveled by the light beam 118, the droplet 402 may affect the shape of an illumination profile 404 on the optical sensor 114. For example, because of the presence of droplet 402, the light beam 118 may not illuminate some light detectors 204 in the array 202 that would otherwise be illuminated. Nonetheless, some of the light detectors 204 may be intermittently illuminated as the substrate 202 rotates. Thus, some light detectors 204 may intermittently output a detection signal despite the presence of the droplet 402, and the controller 108 may determine rotation frequency even in a wet environment.

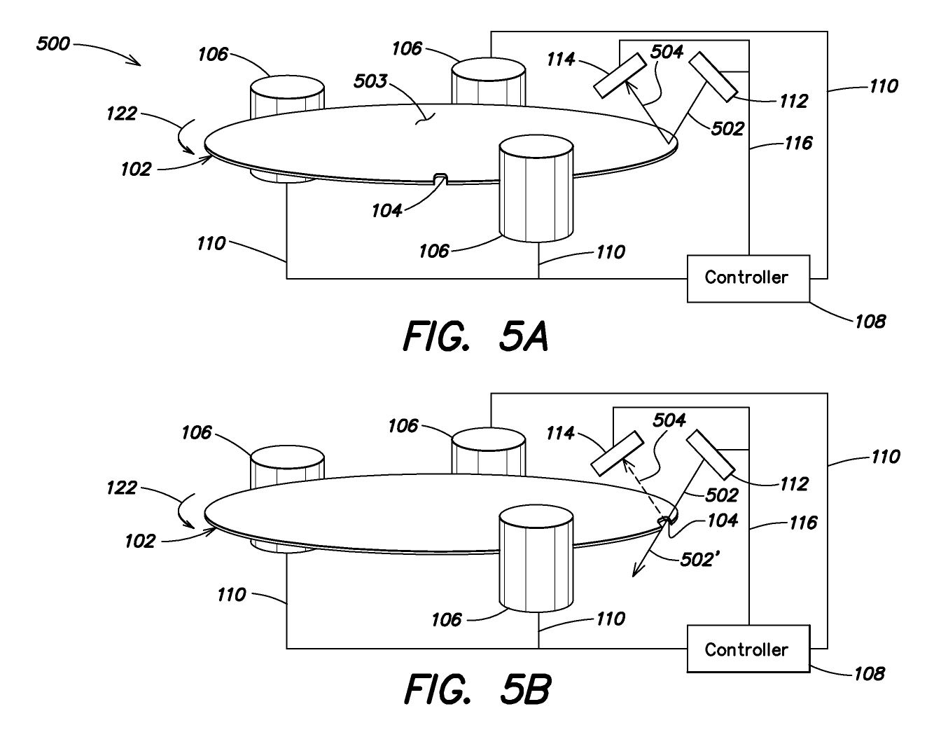

FIGS. 5A and 5B illustrate front perspective views of the feature 104 of the substrate 102 being detected by the optical sensor 114 as the substrate 102 is rotated in accordance with an additional embodiment of the present invention. With reference to FIG. 5A, a second exemplary cleaning apparatus 500 is provided that holds, rotates and cleans the substrate 102. The second exemplary cleaning apparatus 500 is similar to the first exemplary cleaning apparatus 100 of FIGS. 1A-1B. However, in the second exemplary cleaning apparatus 500, a light beam 502 travels from the optical source 112 to a top major surface 503 of the substrate 102 such that at least a portion of the light beam 502 is reflected from the top surface 503 of the substrate 102. The reflected portion of the light beam 502 illuminates the optical sensor 114 which is positioned to receive the reflected light beam (along a path 504).

With reference to FIG. 5B, the apparatus 500 may rotate the substrate 102 such that the orientation feature 104 traverses the path 504. In such instances, a portion 502′ of the light beam 502 passes by the substrate 102 through the feature 104 so that a smaller portion of the light beam 502 is reflected toward the optical sensor 114. By reflecting a smaller portion of the light beam 502, a smaller portion of the optical sensor 114 is illuminated. Consequently, fewer detectors 204 within the optical sensor 114 are illuminated, so that the controller 108 may identify the presence of the orientation feature 104 and determine substrate rotation frequency (as described above).

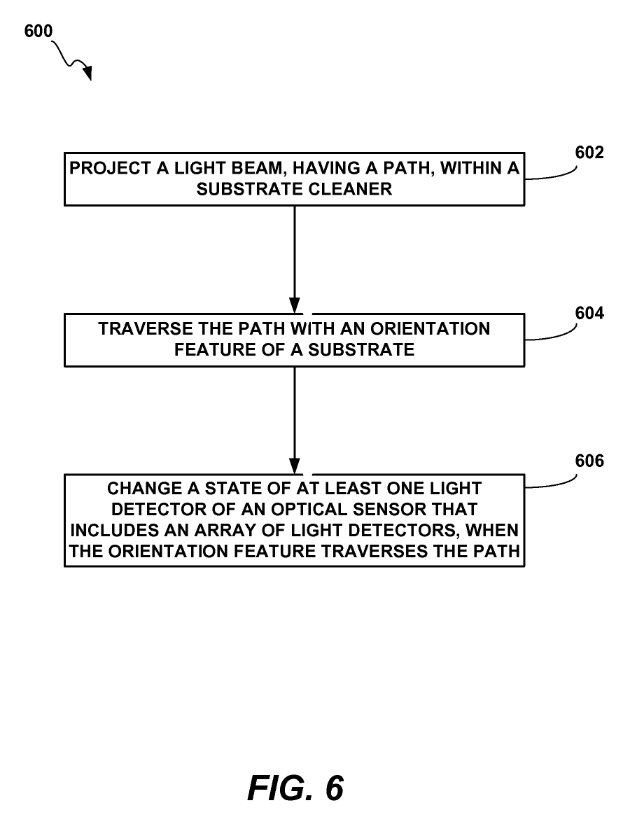

Turning to FIG. 6, an example method 600 of monitoring movement of a substrate is depicted in flowchart form. It should be understood that although a specific sequence of only three steps are depicted, the number and order of the steps is merely exemplary and numerous additional or alternative sequences, steps, sub-steps, and super-steps may be combined or divided out in different orders (or in parallel) from the example steps depicted or other steps.

In step 602, a light beam is projected within a substrate cleaner. The light beam follows a path that may be normal to the major surface of the substrate, or in alternative embodiments (as depicted for example in FIGS. 5A & 5B), may be angled (e.g., 45 degrees) relative to the plane of the substrate's major surface. The path may be disposed to be partially incident on the edge of the substrate and the path may include a reflected portion, for example, in the case of the light beam being angled relative to the plane of the substrate's major surface.

In step 604, the path is traversed by an orientation feature (e.g., a notch, a flat, a marking, etc.) of the substrate. The traversing of the path may occur as the substrate is rotated, for example, while the substrate is being cleaned.

In step 606, the state of at least one light detector of an optical sensor is changed when the orientation feature traverses the path. As described above, the optical sensor may include an array of light detectors and the state change may represent the passage of the orientation feature through the path. In other words, as the orientation feature traverse the path, at least one light detector will change state, e.g., either from detecting light to not detecting light or from not detecting light to detecting light.

The foregoing description discloses only exemplary embodiments of the invention. Modifications of the above disclosed apparatus and methods which fall within the scope of the invention will be readily apparent to those of ordinary skill in the art. For instance, a cleaning apparatus including multiple light sources disposed in the same or different locations may be employed. Components such as the optical source and/or optical sensor may be controlled and/or communicate with the controller 108 wirelessly, via wires or via any suitable means.

Accordingly, while the present invention has been disclosed in connection with exemplary embodiments thereof, it should be understood that other embodiments may fall within the spirit and scope of the invention, as defined by the following claims.

The invention claimed is:

1. A system for monitoring rotation of a substrate during cleaning comprising:
a substrate cleaner adapted to support and clean a substrate;
an optical source adapted to provide a light beam having a path within the substrate cleaner; and
an optical sensor positioned along the path so as to receive the light beam from the optical source and adapted to detect an orientation feature on the substrate when the orientation feature traverses the path,
wherein the optical sensor includes an array of light detectors.

2. The system of claim 1, wherein the orientation feature is at least one of a notch and a flat.

3. The system of claim 1, wherein the path is normal to a major surface of the substrate.

4. The system of claim 1, wherein the path is angled relative to a major surface of the substrate and the path changes to include a reflected portion based on a position of the orientation feature.

5. The system of claim 1, wherein the path is disposed proximate to an edge of the substrate.

6. The system of claim 1, wherein the substrate cleaner deposits a fluid on the substrate during cleaning and wherein the optical sensor is adapted to detect the orientation feature independent of the fluid being present in the path.

7. The system of claim 1, wherein the array of light detectors includes a plurality of light detectors disposed in a line extending radially from a center of the substrate.

8. An apparatus for monitoring rotation of a substrate comprising:
an optical source adapted to provide a light beam having a path partially incident on a substrate; and
an optical sensor positioned along the path so as to receive the light beam from the optical source and adapted to detect an orientation feature on the substrate when the orientation feature traverses the path,
wherein the optical sensor includes an array of light detectors.

9. The apparatus of claim 8, wherein the orientation feature is at least one of a notch and a flat.

10. The apparatus of claim 8, wherein the path is normal to a major surface of the substrate.

11. The apparatus of claim 8, wherein the path is angled relative to a major surface of the substrate and the path changes to include a reflected portion based on a position of the orientation feature.

12. The apparatus of claim 8, wherein the path is disposed proximate to an edge of the substrate.

13. The apparatus of claim 8, wherein the optical sensor is adapted to detect the orientation feature independent of changes in an amount of the light beam being obstructed from reaching the optical sensor.

14. The apparatus of claim 8, wherein the array of light detectors includes a plurality of light detectors disposed in a line extending radially from a center of the substrate.

15. A method of monitoring rotation of a substrate during cleaning comprising:
projecting a light beam, having a path, within a substrate cleaner;
traversing the path with an orientation feature of a substrate; and
changing a state of at least one light detector of an optical sensor that includes an array of light detectors, when the orientation feature traverses the path.

16. The method of claim 15 wherein projecting a light beam includes projecting a light beam at an edge of a substrate so that the light beam is partially incident on the edge of the substrate.

17. The method of claim 15 wherein projecting a light beam includes projecting a light beam at an edge of a substrate so that the light beam is substantially normal relative to a major surface the substrate.

18. The method of claim 15 wherein projecting a light beam includes projecting a light beam at an edge of a substrate so that the light beam is angled relative to a major surface the substrate.

19. The method of claim 18 wherein projecting a light beam includes projecting a light beam so that the path includes a reflected portion.

20. The method of claim 15 wherein traversing the path with an orientation feature of the substrate includes rotating the substrate to cause the orientation feature to pass through the light beam.

21. The method of claim 15 wherein changing the state of at least one light detector results from the orientation feature allowing at least some of the light beam to reach the optical sensor when the orientation feature traverses the path.

23. The method of claim 15 wherein changing the state of at least one light detector results from the orientation feature preventing at least some of the light beam from reaching the optical sensor when the orientation feature traverses the path.

24. The method of claim 15 wherein the array of light detectors is disposed to allow the state of at least one light detector to change in response to the orientation feature traversing the light beam even if the orientation feature is partially blocked.

25. The method of claim 15 further including adjusting a speed of rotation of the substrate based on a rate at which the at least one light detector changes state.
